(19) United States
(12) Patent Application Publication
(10) Pub. No.: US 2019/0047829 A1
(43) Pub. Date: Feb. 14, 2019

(54) MOBILE HEAVE COMPENSATOR

(71) Applicant: SAFELINK AS, PORSGRUNN (NO)

(72) Inventors: TORD B MARTINSEN, PORSGRUNN (NO); ANDRE SKARE BERG, SKIEN (NO)

(21) Appl. No.: 16/079,022

(22) PCT Filed: Feb. 22, 2017
(86) PCT No.: PCT/NO2017/050048

§ 371 Date: Aug. 22, 2018

(30) Foreign Application Priority Data
Feb. 22, 2016 (NO) 20160299
Jul. 18, 2016 (NO) 20161184

(51) Int. Cl. B66C 13/02; B66C 13/04; B66C 23/52

(52) U.S. Cl. CPC B66C 13/02; B66C 23/52; B66C 13/04

(57) ABSTRACT

This document describes a mobile heave compensator (100) provided with an attachment device (15) for suspending the compensator from a load bearing device (102) and an attachment device (14) for carrying a payload (101). The compensator comprises a passive heave compensation part and possibly an active heave compensation part, and being associated with a sensor arrangement producing input signals for a control unit and a power source (71). The compensator (100) incorporates a gas pump and/or motor device (70), affecting the passive heave compensating part, producing output signal(s) to the gas pump device (70), based on input signals received from the sensor arrangement, to enable flow of gas towards a volume with a higher pressure.

### TECHNICAL FIELD OF THE INVENTION

Mobile heave compensator provided with an attachment device for suspending the compensator from a load bearing device and an attachment device for carrying a payload, comprises a passive heave compensation part and possibly an active heave compensation part, and being associated with a sensor arrangement producing input signals for a control unit and a power source.

The mobile heave compensator is an installation tool that is intended at one end to be directly or indirectly suspended from a lifting device or the like and at the other end intended to carry a payload or the like. Moreover the mobile heave compensator is an independent unit that is not made as an integrated part of a crane or a lifting unit, but may be transported between different lifting vessels without having to modify the crane or lifting system onboard the various vessels. Moreover, the mobile heave compensator is designed to compensate vertical heave motion during sensitive installation of subsea equipment in an offshore environment. The vertical heave source is typically generated by vessel motion and/or crane tip motion. The mobile heave compensator is designed to operate in air or in water. The mobile heave compensator is an inline tool that uses the principles of spring isolation to generate a net heave compensation effect or spring isolation effect. The tool can be a nitrogen-over-oil spring-dampening device.

### BACKGROUND OF THE INVENTION

The following prior art patents and articles are relevant for this application: “Subsea Heave Compensators”, 2009 paper by Bob Wilde and Jake Ormond. The paper describes usage of valves to increase and decrease gas pressure in a heave compensator. Gas release to surroundings is also described.

NO 20140672—Self adjusting heave compensator. Describes how a position sensor can be used to control the equilibrium position of a heave compensator piston by adjusting gas pressure up or down by use of valves between tanks with a differential pressure that allows flow (i.e. increase pressure by injecting gas from a high-pressure tank into the main accumulator and reduce pressure by releasing gas from the main accumulator into a tank with lower pressure).

U.S. Pat. No. 4,724,970 A—Compensating device for a crane hook. The compensation design shown has hydraulic fluid on both sides of the actuator piston connected to gas accumulators.

US 2008/251980 A1—Depth compensated subsea passive heave compensator. The compensation design shown has hydraulic fluid on both sides of the actuator piston connected to a gas accumulator and a depth compensation cylinder.

Many prior art active heave compensators exist, like the one described in e.g. US 2010/0057279 A1.

One disadvantage with the prior art solution is that traditional active compensators often do not have a passive backup system and always stay topside on an installation vessel.

Another major disadvantages of the prior art solutions are: high capital binding in permanent installed (i.e. not mobile) equipment which is often only needed a few weeks per year, high installation costs, high maintenance costs (especially related to fatigue in steel wire rope), poor splash zone crossing performance due to fast dynamics, poor performance for short wave periods due to fast dynamics, poor resonance protection, high power demand and lack of models for heavy lifts.

The main difference between the prior art and the invention is the manner in which the depth compensation is obtained. The prior art compensation solutions are completely passive, i.e. it does not require an energy source, utilizing a pressure intensifier principle to compensate the effect of the water pressure acting on the piston rod. This requires a second hydraulic cylinder connected to the main hydraulic cylinder. The main disadvantages of the prior art are: added cost of the compensation cylinder, added friction (hydraulic seal friction) from the compensation cylinder, added weight of the compensation cylinder and oil, added inertia of the moving parts of the compensator, and most important: the gas spring stiffness of the compensator is higher than needed, because the water pressure carries zero of the load acting on the piston rod.

### SUMMARY OF THE INVENTION

In the following through out the specification the following terms means:

An active heave compensation part is an element connected together with a passive motion compensation system in order to: i) significantly reduce the tension variation/spring force in the passive system; ii) to obtain a constant tension during the heave period; and iii) manipulating the total system, both passive and active together in order to obtain a close to exact cylinder stroke based on a motion reference unit, i.e. for smooth landing of equipment on a surface, for example either on a seabed or on another body.

The term “cylinder” used in this specification means a closed body with an inner enclosed volume, configured to withstand the required internal and/or external pressure and being provided with a fluid inlet and/or fluid outlet.

The term “vacuum” means a pressure less than two bar and preferably s low as possible towards a non-pressure.

The term “device for hydraulic fluid transportation” can represent hydraulic pumps in series or parallel and includes all valves and sensors needed for operation.

The term “device for gas transportation” can represent a gas compressor or gas booster driven by either hydraulics or compressed air.

The term “conduit device” can represent tubing, piping, or manifolds with internal channels connecting one or more volumes, valves, pumps or other equipment.

The term “pressure intensifier” is a hydraulic machine for transforming hydraulic power at low pressure into a reduced volume at higher pressure.

The term “double acting pressure intensifier” means a hydraulic machine for transforming hydraulic power at low pressure into a reduced volume at higher pressure, but with a higher efficiency than a single acting intensifier.

The term “depth compensator” means a device suitable to compensate for external water pressure acting on the actuator piston rod.

The term “energy source” means an energy source that powers the compensator, including the device for hydraulic fluid transportation, and may be a large battery pack or an umbilical.

An inline heave compensator is a mobile compensation device, intended to be connected to the crane hook and a payload, where the compensator is suitable to reduce dynamic force and motion acting on the payload as well as dynamic force acting on the crane.

Tanks may be connected to any volume to increase its size.

It is often possible to replace a fluid type with another one and still maintain functionality

Oil means any liquid (e.g. glycol water mix)

Most components can be connected in parallel to increase its size or capacity.

The main object of the present invention is to provide an inline heave compensator that is capable of active position/speed control of the actuator while still being mobile, i.e. a loose lifting gear, and not needing an external energy source.

Another object of the present invention is to provide an inline heave compensator that eliminates, or at least substantially reduces wear and tear of a crane wire rope and a crane system used for offshore heavy lifts from a floating installation on to a sea bed installation or to a fixed or floating unit, such as a barge.

Another object of the present invention is to provide an inline heave compensator with enhanced performance, increasing the availability and operational weather window, i.e. allowing crane vessel to operate in rougher seas without increasing the hazard correspondingly.

Yet another object of the present invention is to provide an inline heave compensator that is more cost effective and more reliable, reducing the downtime of the crane vessel.

An even further object of the present invention is to provide an inline heave compensator eliminating the relative wave induced movement between the payload and an installation unit, either on the sea bed or on a barge.

Yet another object of the present invention is to provide an inline heave compensator with reduced weight without reducing the performance or the capacity of the heave compensator and/or providing enhanced precision when landing the payload.

Another object of the present invention is to provide a semi-active or an active inline heave compensator, or a mobile active inline heave compensator possibly with incorporated a system or arrangement for compensation of
depth,
temperature,
weight inaccuracy, and
buoyancy.

The objects are achieved by a mobile heave compensator as described in the dependent claims, while embodiments, alternative compensators and variants are defined by the independent claims.

The novel design of the mobile heave compensator is use of active control of gas pressure to compensate for depth effect. The solution hereby presented is used to adjust the pressure on the rod side and/or the piston side of the actuator. Manipulating/adjusting of the pressure within the actuator might happen either with an active device for gas transportation, making the mobile heave compensator an active mobile heave compensator or an intricate valve and tank design combined with an integrated gas booster as a mobile heave compensator.

The active device for gas transportation is used to adjust the pressure beneath a first or main piston within a first cylinder. When the water pressure increases, the internal gas pressure of a second cylinder needs to be lowered in order to keep the intended equilibrium position constant. When the water pressure increases, the gas pressure is lowered, so that the equilibrium position of the first or main piston is kept constant.

The equilibrium position is calculated by using a third order filter with continuous variable filter time on the measurements from a sensing arrangement or devices, which can be e.g. a linear position sensor that senses the position of the main piston. It is also possible to use an accumulator piston within the second cylinder as reference and then measure the position of this piston with another linear sensor, as the movement of the accumulator piston and the main piston is linked by simple or appropriate mathematical relation(s) and/or equation(s). Other than linear sensors and position sensors that are suitable for the purpose can also be used in the sensing arrangement, such as, but not limited to wire sensor(s), pressure sensor(s), temperature sensor(s), laser(s) or based on ultrasound. There can also be used suitable sensors that can measure or sense the position of a piston rod. For example, at least one pressure sensor adapted for measuring the pressure in each of the gas volumes and at least one pressure sensor adapted for measuring the external pressure (i.e. the pressure of the surroundings (e.g. the sea or ocean)) together with at least one temperature sensor adapted for measuring the surroundings temperature can be used as the sensing arrangement in order to indirectly measure the equilibrium position of the main piston and/or the piston rod in the first cylinder relative to at least one of the ends of the first cylinder. The equilibrium position of the first piston can then be calculated based on appropriate mathematical relation(s) and/or equation(s).

It is also possible to control the hydraulic fluid or the gas transportation device when having in mind that the net force on the payload or load should be constant. This can be achieved by regulating the pressure on the upper side of the first or main piston. When the pressure on the lower side of the main piston increases due to gas compression, the pressure on the upper side of the main piston will simultaneously increase so that the net force will be zero.

The intricate valve and tank design combined with an integrated gas booster is used to adjust the pressure on the piston side and the rod side of the actuator. The size of the volume connected to the piston side and the rod side of the actuator can be varied by opening and closing valves, optimizing the characteristics of the compensator to the current water depth. The system is well suited to compensate other effects like buoyancy and temperature influence. The system is controlled with a computer that acts upon measurements of gas pressures, external pressure and piston positions.

During the start of the lift the pressure on the piston side of the actuator is zero and the pressure of the tank(s) connected to the piston side of the actuator is also zero, the pressure on the rod side of the actuator is adapted to carry the weight of the payload in center stroke position (or any desired equilibrium position), the tanks connected to the rod side of the actuator also has the same pressure. As the unit is lowered deeper into the sea, gas is either released into the sea, transferred to other tanks or transferred to the piston side volume of the actuator. The compensator can operate at basically any water depth as it can manipulate the pressure on both sides of the actuator piston to adjust for external pressure and temperature variations. Under conditions where flow cannot be achieved (i.e. due to too high counter pressure) with just valves, a gas booster driven by a hydraulic pump is used to force flow.

### BRIEF DESCRIPTION OF THE DRAWINGS

FIGS. 3-6 are schematic illustrations of four versions or embodiments of the mobile heave compensator according to the present invention in which the major component parts of the heave compensator are specifically identified.

FIG. 1 is an illustration of a prior art depth compensated heave compensator.

FIG. 2 shows the placement of the mobile heave compensator elative to the vessel and the subsea equipment.

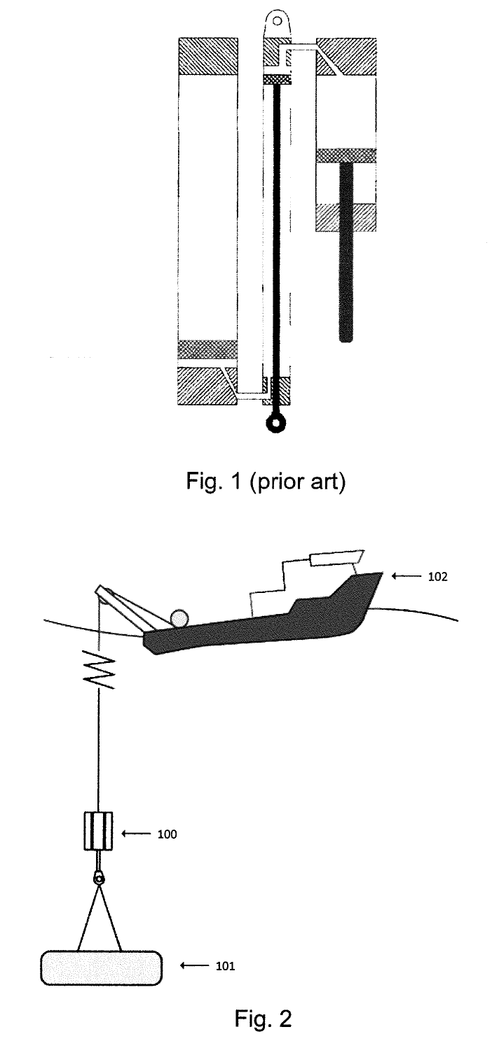

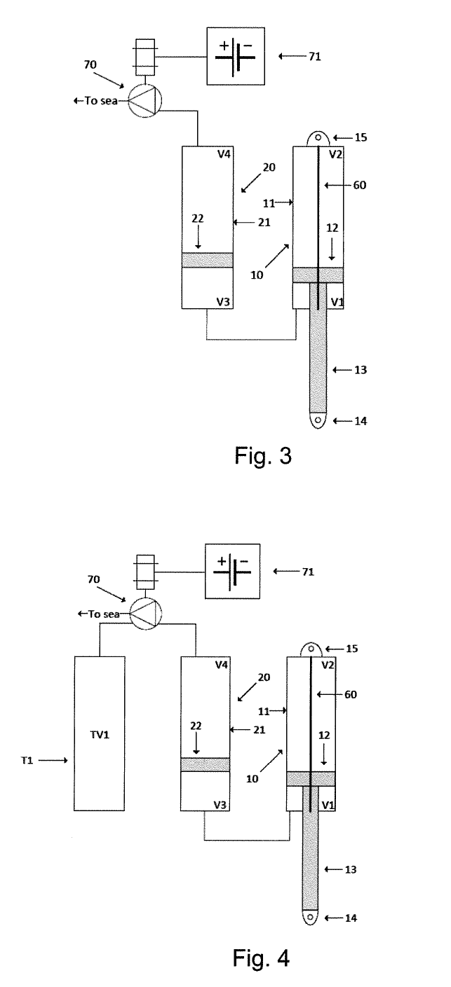

FIG. 3 shows the most basic version or embodiment of the mobile heave compensator, according to the invention, with the lowest cost.

FIG. 4 shows another version or embodiment of the mobile heave compensator, according to the invention, that allows both pressure decrease and increase.

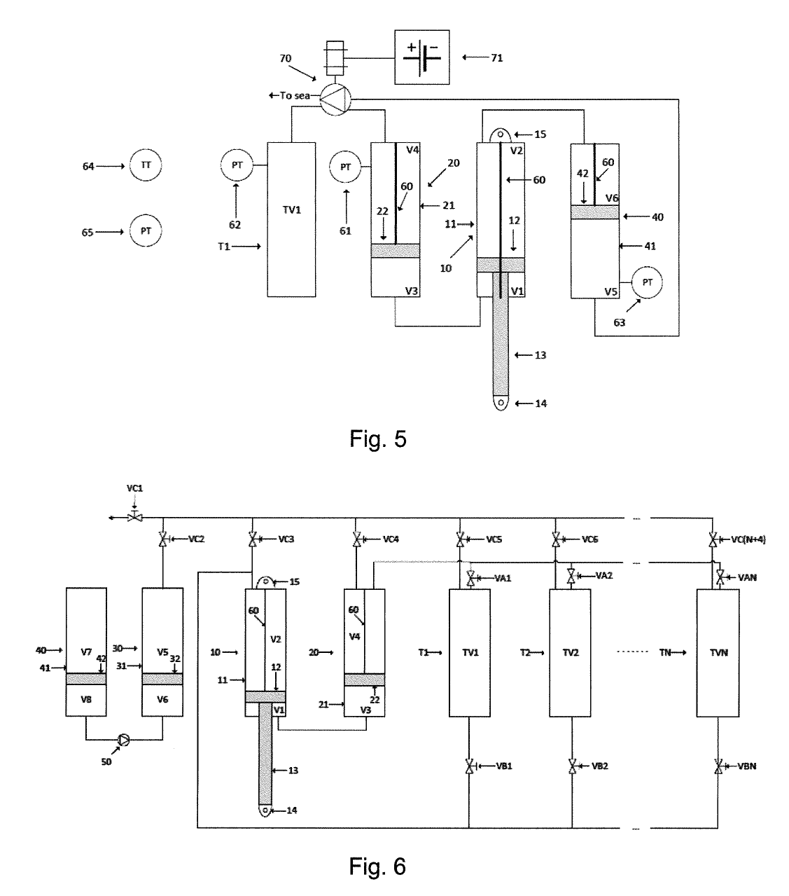

FIG. 5 shows yet another version or embodiment of the mobile heave compensator, according to the invention, that allows decrease and increase in pressure as well as the ability to operate at deep waters with light payloads. Some extra sensors that can be used to calculate the equilibrium position of the first piston and/or the rod are also shown.

FIG. 6 is a schematic illustration of the mobile heave compensator according to the present invention in which the major component parts of the heave compensator are specifically identified.

### DETAILED DESCRIPTION OF EMBODIMENT S DISCLOSED IN THE DRAWINGS

The following description of exemplified embodiments refers to the accompanying drawings. The same reference numbers in different drawings identify the same or similar elements. The following detailed description does not limit the invention. Instead, the scope of the invention is defined by the appended claims. The following embodiments are discussed, for simplicity with regards to the terminology and structure of a compact mobile heave compensator showing ion principle the relation between the various elements being integrated in the compensator, but not showing the physically assembled product. Moreover, the various elements forming the mobile active heave compensator are only schematically shown.

Reference throughout the specification to “one embodiment” or “an embodiment” means that a particular feature, structure, or characteristic described in connection with an embodiment is included in at least one embodiment of the subject matter disclosed. Thus, the appearance of the phrases “in one embodiment” or “in an embodiment” in various places throughout the specification is not necessarily referring to the same embodiment. Further, particular features, structures, or characteristics may be combined in any suitable manner in one or more embodiments.

It should be noted that the various hydraulic cylinder types shown in FIG. 3 may be used in various embodiments and/or constellations according to the present invention without deviated from the inventive concept.

The sketches or embodiments, shown on FIGS. 3-6, are intended to show the principles, with variations in where gas is stored, where the equilibrium position is measured and how deep the compensator can operate.

FIG. 1 shows schematically a view partly in section of a prior art passive heave compensator comprising an actuator in the form of a cylinder, a piston and a piston rod extending through the lower end wall of the cylinder, the piston being configured to reciprocate inside the cylinder, the top end of the cylinder being provided with a padeye for fixture to the end of a crane hook while the lower end of the piston is correspondingly provided with a padeye, allowing a payload to be suspended from the piston rod. The actuator piston divides the actuator cylinder into an upper and a lower volume. Moreover, the prior art heave compensator is provided with an actuator in the form of a cylinder and with a reciprocating piston therein, dividing the cylinder onto an upper and a lower volume. The lower volume in the actuator is in fluid communication with a lower volume in an accumulator. The prior art heave compensator is also provided with a depth compensating unit in the form of a cylinder, a piston and a piston rod extending through an end wall of the cylinder the end surface of the piston rod being exposed to the external water pressure, tending to force the piston rod and the piston upwards in the cylinder. The upper volume in the depth compensating unit is in fluid communication with the upper volume of the actuator.

FIG. 2 shows schematically how the mobile heave compensator (100) is normally rigged to a work wire coming from the vessel (102) at the first connection means (15) and to the payload (101) at second connection means (14), where connection means (14, 15) can be at least one of: a padeye and a clevis, but not limited only thereto.

The version or embodiment of the mobile heave compensator (100), shown in FIG. 3, is only able to lower (i.e. not increase) the internal gas pressure of the first gas accumulator (20)/second cylinder (21). This principle can only operate as long as some of the load from the subsea equipment (101) is carried by the internal gas pressure. For light payloads and deep waters this is not always the case (i.e. the required gas pressure in first gas accumulator (20)/the second cylinder (21) for correct equilibrium is negative, which is physically impossible).

The version or embodiment of the mobile heave compensator (100), shown in FIG. 4, can both decrease and increase the internal gas pressure of the first gas accumulator (20)/second cylinder (21) by utilizing a gas tank (T1) as a gas reservoir. This principle can only operate as long as some of the load from the subsea equipment (101) is carried by the internal gas pressure. For light payloads and deep waters this is not always the case (i.e. the required gas pressure in the first gas accumulator (20)/second cylinder (21) for correct equilibrium is negative, which is physically impossible).

The version or embodiment of the mobile heave compensator (100), shown in FIG. 5, can both decrease and increase the gas pressure in the first gas accumulator/second cylinder (21) by utilizing the gas tank (T1) as a gas reservoir. A fourth cylinder (41) is added. The fourth cylinder (41) can either be a gas tank or accumulator (40). By pressurizing the fourth cylinder (41), a force is generated that will partly counteract the force generated by the seawater pressure acting on the piston rod (13). It is now possible to operate at any depth with any payload weight (i.e. with a positive pressure in the second cylinder (21)). Alternative and/or additional placements for position sensors are also shown, indicated by the second piston (22) position sensor (60) and the third piston (42) position sensor (60).

The device for gas transportation (70) of the mobile heave compensator (100) is powered by an energy source (71), which can be either at least one battery pack (71) or an energy source (71) on the vessel (102) connected to the mobile heave compensator (100) via an umbilical. Typically, the device for gas transportation (70) would be at least one pressure intensifier or at least one gas compressor driven by either hydraulics, such as e.g. an electrically powered hydraulic pump setup or directly by an electric motor.

As previously mentioned, FIG. 3 illustrates the basic version or embodiment of the mobile heave compensator (100) with all of the major sub-components numbered. In Table 1 below, the component description is identified. The mobile heave compensator (mobile heave compensator) (100) is normally rigged to a work wire of a vessel (102) at a first connection device (15), where the first connection device (15) is normally facing up and a second connection device (14) is facing down. The second connection device (14) can also be connected to subsea equipment (101) if desired or necessary. The subsea equipment (101) is normally attached to the second connection device (14). The vessel (102) can also be connected to second connection device (14) if desired or necessary. The connection device (14, 15) can be at least one of: a padeye and a clevis, but not limited only thereto. A second cylinder (21), which normally can be an accumulator, has at its lower end fluid communication with the rod side of a first cylinder (11) via a conduit device and is pre-charged, such that the static position of a piston rod (13) of the first cylinder (11) is mid-stroke when the subsea equipment (101) is submerged. The piston rod (13) strokes up and down with vessel motion to produce compensation for the subsea equipment (101). When the piston rod (13) strokes down, hydraulic fluid from the first cylinder (11) is transported into the hydraulic fluid side of the second cylinder (21). The hydraulic fluid can normally be a mineral oil or a glycol-water fluid, but not limited only thereto. As the hydraulic fluid moves into the second cylinder (21), a second piston (22) therein displaces upwards and compresses the gas above second piston (22). The gas can normally be nitrogen or air, but not limited only thereto. The compression of gas in the second cylinder (21) creates an effective spring.

When the mobile heave compensator (100) is submerged, the external water pressure produces a net hydrostatic pressure acting on the cross sectional area of the piston rod (13) of the first cylinder (11), which generates an axial force on the piston rod (13). This force is utilized to carry part of the load generated by the weight of the subsea equipment (101) being installed. To maintain correct equilibrium of the piston rod (13), it is necessary to reduce the gas pressure in the second cylinder (22). The equilibrium position of the piston rod (13), relative to at least one of the ends of the first cylinder (11), is calculated based on measurements from a first piston (21) position sensor (60). Reduction of the gas pressure in the second cylinder (21) is done by using a device for gas transportation (70) to transport gas from the second cylinder (21) to the surroundings (i.e. sea or ocean).

FIG. 4 shows another version or embodiment of the mobile heave compensator (100), similar to the one in FIG. 3, with the addition of a gas tank (T1), that is used as a gas reservoir. The gas tank (T1) is used to store excess gas, instead of expelling it to the surroundings. One advantage of the gas tank (T1) is that it allows the mobile heave compensator (100) to both increase and decrease pressure, which is necessary in several cases, e.g. if compensation is needed for a lift from subsea to topside.

FIG. 5 shows yet another version or embodiment of the mobile heave compensator (100), similar to the one in FIG. 4, with the addition of a fourth cylinder (41), which normally can be an accumulator (40), but it can also be a tank (40). The hydraulic fluid side of the fourth cylinder (41) is connected to the piston or upper side of the first cylinder (11) via a second conduit device. The fourth cylinder (41) allows the mobile heave compensator (100) to operate even with light payloads at deep waters.

According to one embodiment of the invention, shown on FIG. 3, a depth mobile heave compensator (100) comprises a first cylinder (11) with a first piston (12) and a second cylinder (21) with a second piston (22). The first piston (12) is located within the first cylinder (11) and is adapted for reciprocation with respect thereto. The second piston (22) is located within the second cylinder (21) and is adapted for reciprocation with respect thereto. The first cylinder (11) has an upper end (15) and a lower end (14). The second cylinder (21) has an upper end and a lower end. A first connection device (15) is arranged on or mounted at the upper end of the first cylinder (11). The first connection device (15) is adapted for connecting the first cylinder (11) to a vessel (102) at sea surface and/or subsea equipment (101). A piston rod (13) is connected to the first piston (12) and extends downwardly therefrom through the lower end of the first cylinder (11). A second connector device (14) is adapted for securing the first piston rod (13) to the vessel (102) at the sea surface and/or the subsea equipment (101). The second connector device (14) is located at the lower end of the first cylinder (11). A first volume (V1) of hydraulic fluid is contained within the first cylinder (11) between the first piston (12) and the lower end of the first cylinder (11). A fourth volume (V4) of gas is located within the second cylinder (21) between the upper end thereof and the second piston (22). A third volume (V3) of hydraulic fluid is located in the second cylinder (21) between the lower end thereof and the second piston (22). A conduit device operably connects the lower end of the first cylinder (11) to the lower end of the second cylinder (21). A device for gas transportation (70) is connected to the upper end of the second cylinder (21) and is adapted to enable pressure reduction in the second cylinder (21) by expelling gas to one of: the surroundings or an additional container or cylinder. A sensing arrangement or device (60) is adapted for direct or indirect measuring an equilibrium position of at least one of: the first piston (12) and the piston rod (13), relative to at least one of: the lower and upper ends of the first cylinder (11). In the first embodiment of the invention, between the upper end of the first cylinder (11) and the first piston (12) there can be vacuum or gas.

The device for gas transportation (70) can be controlled based upon the direct or indirect measurements from the sensing arrangement (60). In the first embodiment of the invention, the sensing arrangement (60) is a first piston (12) position sensor (60) arranged within the first cylinder (11) for direct measurements. An alternative way to control the device for gas transportation (70) is to use pressure sensors (61, 62, 63) to measure the pressure in each gas volume combined with a pressure sensor (65) adapted for external pressure measuring and a temperature sensor (64) adapted to measure the external temperature (i.e. the pressure of the surroundings). The readings of the sensors can be used to indirectly calculate the equilibrium position of the first piston (12) and/or the rod (13) using an equation of state.

Alternatively, at least one pressure sensor (61, 62, 63) adapted for measuring the pressure in each of the gas volumes and at least one pressure sensor (65) adapted for measuring the external pressure (i.e. the pressure of the surroundings (e.g. the sea or ocean)) together with at least one temperature sensor (64) adapted for measuring the surroundings temperature can be used as the sensing arrangement in order to indirectly measure the equilibrium position of the main or first piston (12) and/or the main rod (13) in the first cylinder (11) relative to at least one of the ends of the first cylinder (11). The equilibrium position of the first piston (12) can then be calculated based on appropriate mathematical relation(s) and/or equation(s).

It is also possible to control the hydraulic fluid or the gas transportation device (70) when having in mind that the net force on the payload should be constant. This can be achieved by regulating the pressure on the upper side of the first piston (12). When the pressure on the lower side of the first piston (12) increases due to gas compression, the pressure on the upper side of the first piston (12) will simultaneously increase, so that the net force will be zero.

The compensator (100) can further comprise, as shown in FIG. 4, a gas tank (T1) having an upper end and a lower end. A first tank volume (V1) of gas is located within the gas tank (T1) between the upper and the lower end thereof. The device for gas transportation (70) is further connected to the gas tank (T1), thus enabling storage of gas from the second cylinder (21) by transporting gas between the second cylinder (21) and the gas tank (T1).

The compensator (100) can further comprise, as shown in FIG. 5, a fourth cylinder (41) having an upper end and a lower end. A third piston (42) is located within the fourth cylinder (41) and is adapted for reciprocation with respect thereto. A fifth volume (V5) of gas is located within the fourth cylinder (41) between the lower end thereof and the third piston (42). A sixth volume (V6) of hydraulic fluid is located in the fourth cylinder (41) between the upper end thereof and the third piston (42). A second volume (V2) of hydraulic fluid is located in the first cylinder (11) between the upper end thereof and the first piston (12). A conduit device operably connects the upper end of the first cylinder (11) to the upper end of the fourth cylinder (41). The device for gas transportation (70) is further connected to the lower end of the fourth cylinder (41), thus enabling transport of gas between the gas tank (T1) and the fourth cylinder (41).

According to yet another embodiment of the invention, the compensator (100) can further comprise a fourth cylinder (41) having an upper end and a lower end and not having a piston therein. A fifth volume (V5) of gas is located within the fourth cylinder (41) between the lower and the upper end thereof. A second volume (V2) of gas located in the first cylinder (11) between the upper end thereof and the first piston (12). A conduit device operably connects the upper end of the first cylinder (11) to the upper end of the fourth cylinder (41). The device for gas transportation (70) is further connected to the fourth cylinder (41), thus enabling transport of gas between the gas tank (T1) and fourth cylinder (41).

The sensing arrangement (60) for direct or indirect position measurement of the first piston (12) can be at least one of: a first piston position sensor (60) adapted for direct measuring the equilibrium position of the first piston (12); a second piston position sensor (60), in a second cylinder (21), being adapted for indirect measuring the equilibrium position of the first piston (12); and a third piston position sensor (60), in a fourth cylinder (41), being adapted for indirect measuring the equilibrium position of the first piston (12).

The device for gas transportation (70) can be at least one gas compressor driven by an electric motor.

Alternatively, the device for gas transportation (70) can be at least one pressure intensifier driven by hydraulics. The hydraulics can be for example a hydraulic pump.

The compensator (100) can be power supplied by an energy source (71). The energy source (71) can be at least one battery pack (71) integrated into the compensator (100). Alternatively, an energy source (71) on the vessel (102) can be connected to the compensator (100) via an umbilical.

The other pistons (22, 42) can move at different speed(s) with respect to the first or main piston (12). The movement between the first piston (12) and/or first piston rod (13) is linked to another piston (22 or 42) by simple or appropriate mathematical relation(s) and/or equation(s).

At least one of the cylinders can be presented or constituted as a group of a predetermined number of cylinders. The predetermined number of cylinders can be arranged in a parallel connection in order to increase the effective volume of at least one of the following: first volume (V1) of hydraulic fluid, second volume (V2) of either hydraulic fluid or gas, third volume (V3) of hydraulic fluid, fourth volume (V4) of gas, fifth volume (V5) of gas, sixth volume (V6) of hydraulic fluid and first tank volume (TV1) of gas.

According to the invention, shown on FIG. 6, a mobile heave compensator (100) comprises an actuator (10), consisting of a first cylinder (11) having an upper end and a lower end, a first piston (12) and a piston rod (13). The first piston (12) is located within the first cylinder (11) and is adapted for reciprocation with respect thereto. The piston rod (13) is connected to the first piston (12) and extending downwardly therefrom through the lower end of the first cylinder (11). Connection device (15) are mounted at the upper end and connection device (14) are mounted at the lower end of the actuator (10), adapted for connecting the mobile heave compensator (100) to a vessel (102) at the sea surface and a payload (101), but not limited only thereto. A first volume (V1), filled with hydraulic fluid, is contained within the first cylinder (11) between the first piston (12) and the lower end of the first cylinder (11). A second volume (V2), filled with gas at any pressure including zero pressure, is contained within the first cylinder (11) between the first piston (12) and the upper end of the first cylinder (11). A first gas accumulator (20), consists of a second cylinder (21), having an upper end and a lower end, and a second piston (22) located within the second cylinder (21) and is adapted for reciprocation with respect thereto. A third volume (V3), filled with hydraulic fluid, is contained within the second cylinder (21) between the second piston (22) and the lower end of the second cylinder (21). A fourth volume (V4), filled with gas at any pressure including zero pressure, is contained within the second cylinder (21) between the second piston (22) and the upper end of the second cylinder (21). A conduit device operably connects the lower end of the first cylinder (11) to the lower end of the second cylinder (21). A number of tanks (T1, T2, . . . , TN) is adapted for gas storage in each tank volume (TV1, TV2, . . . , TVN), where the number of tanks is minimum one, but can be any number. A number of conduit device between each tank volume (TV1, TV2, . . . , TVN) and the fourth volume (V4), with a number of valve device (VA1, VA2, . . . , VAN) in each conduit device adapted for separating each tank volume (TV1, TV2, . . . , TVN) individually from the fourth volume (V4). A number of conduit device between each tank volume (TV1, TV2, . . . , TVN) and the second volume (V2), with a number of valve device (VB1, VB2, . . . , VBN) in each conduit device adapted for separating each tank volume (TV1, TV2, . . . , TVN) individually from the second volume (V2). The valves may be operated manually (e.g. by a diver or an ROV) or automatically (by a computer) based on logic programming and sensor measurements adapted for measuring the position of the first piston (12) or second piston or both and/or pressure sensor devides adapted for measuring pressure in at least one volume and/or the external pressure. Further conduit devices connecting all gas volumes (V2, V4, TV1, TV2, . . . , TVN) together and adapted with a number of valve devices (VC3, VC4, VC5, VC6, . . . , VC(N+4)) adapted for controlling flow between each individual volume allows fine adjustment of pressure between the two or more volumes. A valve (VC1) is adapted for transport of gas to and from the surroundings from any of the gas volumes (V2, V4, TV1, TV2, . . . , TVN) via conduit devices and other valves (VC3, VC4, VC5, VC6, . . . , VC(N+4)). This valve can be used to fill or drain any gas volume that it is connected to. A second gas accumulator (30), consists of a third cylinder (31), having an upper end and a lower end, and a third piston (32) located within the third cylinder (31) and adapted for reciprocation with respect thereto. A fifth volume (V5), filled with gas at any pressure including zero pressure, is contained within the third cylinder (31) between the third piston (32) and the upper end of the third cylinder (31). A sixth volume (V6), filled with hydraulic fluid, is contained within the third cylinder (31) between the third piston (32) and the lower end of the third cylinder (31). A third gas accumulator (40), consists of a fourth cylinder (41), having an upper end and a lower end, and a fourth piston (42) located within the fourth cylinder (41) and adapted for reciprocation with respect thereto. A seventh volume (V7), filled with gas at any pressure including zero pressure, is contained within the fourth cylinder (41) between the fourth piston (42) and the upper end of the fourth cylinder (41). An eighth volume (V8), filled with hydraulic fluid, is contained within the fourth cylinder (41) between the fourth piston (42) and the lower end of the fourth cylinder (41). Conduit devices between the fifth volume (V5) and other gas volumes (V2, V4, TV1, TV2, . . . , TVN, surroundings) adapted with a valve (VC2) for controlling flow in and out of the fifth volume (V5) via a valve (VC2) and other valves (VC1, VC3, VC4, VC5, VC6, . . . , VC(N+4)). Conduit devices between the eighth volume (V8) and the sixth volume (V6) is fitted with a device for fluid transportation (50) that allows gas flow between any two sets of volumes (including the surroundings), even when the pressure gradient is in disfavor of flow in the wanted direction. This is done by letting gas into the fifth volume (V5) by opening the VC2 valve as well as the valve from the volume one wants to reduce pressure in, then valve VC2 plus the other valve is closed, the device for fluid transportation (50) transports fluid into the sixth volume (V6) and compresses the gas in the fifth volume (V5), then the compressed gas is transported into the volume that one wants pressure increase in by opening valve VC2 and the valve connected to the volume one wants pressure increase in. Some volumes of the compensator can have different fluids or no fluid and still maintain function of the compensator. It is possible (and likely to be done) that an accumulator, actuator or tank is added in parallel or a serial connection to any of the defined accumulators, actuators or tanks to increase volume or capacity.

| Comp. | Description |
|---|---|
| 10 | Actuator |
| 11 | First cylinder |
| 12 | First piston |
| 13 | Piston rod |
| 14 | Connection device |
| 15 | Connection device |
| 20 | First gas accumulator |
| 21 | Second cylinder |
| 22 | Second piston |
| 30 | Second gas accumulator |
| 31 | Third cylinder |
| 32 | Third piston |
| 40 | Third gas accumulator |
| 41 | Fourth cylinder |
| 42 | Fourth piston |
| 50 | Device for fluid transportation |
| 60 | Sensor device |
| 61 | Pressure sensor |
| 62 | Pressure sensor |
| 63 | Pressure sensor |
| 64 | Temperature sensor |
| 65 | Pressure sensor |
| 70 | Devide for gas transportation |
| 71 | Energy source |
| 100 | Mobile heave compensator |
| 101 | Payload |
| 102 | Vessel |
| V1 | First volume |
| V2 | Second volume |
| V3 | Third volume |
| V4 | Fourth volume |
| V5 | Fifth volume |
| V6 | Sixth volume |
| V7 | Seventh volume |
| V8 | Eighth volume |
| T1 | First tank |
| T2 | Second tank |
| TN | Nth rank |
| VA1 | First valve A |
| VA2 | Second valve A |
| VAN | Nth valve A |
| VB1 | First valve B |
| VB2 | Second valve B |
| VBN | Nth valve B |
| VC1 | First valve C |
| VC2 | Second valve C |
| VC3 | Third valve C |
| VC4 | Fourth valve C |
| VC5 | Fifth valve C |
| VC6 | Sixth valve C |
| VC (N + 4) | (N + 4)th valve C |

1. Mobile heave compensator provided with an attachment device for suspending the compensator from a load bearing device and an attachment device for carrying a payload, comprises a passive heave compensation part and possibly an active heave compensation part, and being associated with a sensor arrangement producing input signals for a control unit and a power source,
wherein the compensator incorporates a gas pump and/or motor device, affecting the passive heave compensating part, producing output signal(s) to the gas pump device, based on input signals received from the sensor arrangement, to enable flow of gas towards a volume with a higher pressure.

2. Mobile heave compensator according to claim 1, wherein the power source and/or the control unit form an integral part of the compensator.

3. Mobile heave compensator according to claim 2, wherein
mobile heave compensator is self supported without any external electric or fluid connection to a surface vessel or connection to an externally arranged high pressure unit.

4. Mobile heave compensator according to claim 3, wherein the compensator comprises at least an actuator and an accumulator and that the hydraulic fluid transportation device affects directly or indirectly pressures appearing in the actuator and/or accumulator.

5. Mobile heave compensator according to claim 4 further comprising:
an actuator, consisting of a first cylinder having an upper end and a lower end;
a first connection means mounted at the upper end of the first cylinder and adapted for connecting the first cylinder to one of: a vessel at the sea surface and a payload;
a first piston located within the first cylinder and adapted for reciprocation with respect thereto;
a piston rod connected to the first piston and extending downwardly therefrom through the lower end of the first cylinder;
a second connection means adapted for securing the first piston rod to the vessel at the sea surface or a payload and located at the lower end of the first cylinder;
a first volume (V1), filled with hydraulic fluid, contained within the first cylinder between the first piston and the lower end of the first cylinder;
a second volume (V2), filled with either hydraulic fluid or gas (at any pressure including zero pressure—mobile heave compensator), contained within the first cylinder between the first piston and the upper end of the first cylinder;
a first gas accumulator, consisting of a second cylinder having an upper end and a lower end;
a second piston located within the second cylinder and adapted for reciprocation with respect thereto;
a third volume (V3), filled with hydraulic fluid, contained within the second cylinder between the second piston and the lower end of the second cylinder;
a forth volume (V4), filled with gas (at any pressure including zero pressure) contained within the second cylinder between the second piston and the upper end of the second cylinder;
a conduit means operably connecting the first volume (V1) to the third volume (V3);
a mean or a valve (VC1) adapted for transport of gas/for gas transportation connected to the fourth volume (V4) of the second cylinder and enabling pressure reduction in the second cylinder by expelling gas to one of the surroundings or an additional container or cylinder;
a sensing arrangement adapted for measuring the position of at least one of: the first piston and the piston rod, relative to at least one of: the lower and upper ends of the first cylinder.

6. Depth compensate passive heave compensator according to claim 5 further comprising:
a means for gas transportation, connected to the upper end of the second cylinder, is further connected to a gas tank (T1), thus enabling storage of gas from the first gas accumulator by transporting gas between the second cylinder and the gas tank (T1)

7. Mobile heave compensator according to claim 6 for use in marine environments, comprising an actuator provided with a reciprocating piston movably arranged in a volume inside the actuator, dividing the volume into a first volume (V1) of hydraulic fluid and a second volume (V2) of hydraulic fluid or gas; a piston rod fixed with one end to the piston and with an opposite end extending out through an end wall of the actuator, an accumulator provided with a piston reciprocating in a volume inside the accumulator dividing the accumulator into two volumes, a third volume (V3) of hydraulic fluid and a fourth volume (V4) of gas, and a conduit arrangement providing fluid communication between the actuator and the accumulator,
further comprising that the compensator is provided with a gas transportation device configured to affecting the pressure in one of the volumes inside the actuator, directly or indirectly, and with a sensor arrangement for direct or indirect measuring the position of one of: the piston in the actuator or the piston in the accumulator, relative to at least one of the lower or the upper end of the volume, controlling the pressure produced by the gas transportation device.

8. Depth compensate passive heave compensator according to claim 7 further comprising:
a gas tank or an accumulator, consisting of fourth cylinder having an upper end and a lower end;
a fifth volume (V5) of gas located within the fourth cylinder between the lower end thereof and the upper end thereof;
a second volume (V2) of gas located in the first cylinder between the upper end thereof and the first piston;
a conduit means operably connecting the upper end of the first cylinder to the upper end of the fourth cylinder
where the means for gas transportation, connected to the gas tank (T1), is further connected to the fourth cylinder, thus enabling transport of gas between the gas tank (T1) and fourth cylinder.

9. Depth compensate passive heave compensator according to claim 7 further comprising:
a gas tank or an accumulator, consisting of fourth cylinder having an upper end and a lower end;
a third piston located within the fourth cylinder and adapted for reciprocation with respect thereto;
a fifth volume (V5) of gas located in the fourth cylinder between the lower end thereof and the third piston;
a sixth volume (V6) of hydraulic fluid located in the fourth cylinder between the upper thereof and the third piston;
a second volume (V2) of hydraulic fluid located in the first cylinder between the upper end thereof and the first piston;
a conduit means operably connecting the upper end of the first cylinder to the upper end of the fourth cylinder
where the means for gas transportation, connected to the gas tank (T1), is further connected to the lower end of the fourth cylinder, thus enabling transport of gas between the gas tank (T1) and fourth cylinder.

10. Depth compensate passive heave compensator according to claim 8, where the sensing arrangement for direct or indirect position measuring of the first piston is at least one of: a first piston position sensor adapted for direct measuring the equilibrium position of the first piston: a second piston position sensor (60), in a second cylinder (21), being adapted for indirect measuring the equilibrium position of the first piston (12); and a third piston position sensor, in a fourth cylinder, being adapted for indirect measuring the equilibrium position of the first piston.

11. Depth compensate passive heave compensator according to claim 9, where the sensing arrangement for direct or indirect position measuring of the first piston is at least one of: a first piston position sensor adapted for direct measuring the equilibrium position of the first piston: a second piston position sensor (60), in a second cylinder (21), being adapted for indirect measuring the equilibrium position of the first piston (12); and a third piston position sensor, in a fourth cylinder, being adapted for indirect measuring the equilibrium position of the first piston.

12. Depth compensate passive heave compensator according to claim 6, further comprising:
a number of tanks (T1, T2, . . . , TN), adapted for gas storages in each tank volume (TV1, TV2, . . . , TVN); where the number of tanks is minimum one.

13. Mobile heave compensator according to claim 12, wherein the sensing arrangement is adapted for direct or indirect measuring the equilibrium position of at least equilibrium of at least one of the pistons.

14. Depth compensate passive heave compensator according to claim 13, further comprising:
the sensing arrangement adapted for direct or indirect measuring an equilibrium position of at least one of: the first piston and the piston rod, relative to at least one of: the lower and upper ends of the first cylinder, where the means for gas transportation is controlled based on the direct or indirect measurements from the sensing arrangement.

15. Depth compensate passive heave compensator according to claim 14, further comprising:
a number of conduit means between each tank volume (TV1, TV2, . . . , TVN) and the fourth volume (V4), with a number of valve means (VA1, VA2, . . . , VAN) in each conduit means adapted for separating each tank volume (TV1, TV2, . . . , TVN) individually from the forth volume (V4);
a number of conduit means between each tank volume (TV1, TV2, . . . , TVN) and the fourth volume (V4), with a number of valve means (VB1, VB2, . . . , VBN) in each conduit means adapted for separating each tank volume (TV1, TV2, . . . , TVN) individually from the second volume (V2).

16. Depth compensated heave compensator according to claim 15 further comprising:
conduit means connecting all gas volumes (V2, V4, TV1, TV2, . . . , TVN) together and adapted with a number of valve means (VC3, VC4, VC5, VC6, . . . , VC(N+4)) adapted for controlling flow between each individual volume.

17. Mobile heave compensator according to claim 16 further comprising:
a valve (VC1) adapted for transport of gas to and from the surroundings from any of the gas volumes (V2, V4, TV1, TV2, . . . , TVN) via conduit means and other valves (VC3, VC4, VC5, VC6, . . . , VC(N+4)).

18. Mobile heave compensator according to claim 17 further comprising:
a second gas accumulator, consisting of a third cylinder, having an upper end and a lower end, and a third piston located within the third cylinder and adapted for reciprocation with respect thereto;
a fifth volume (V5), filled with gas at any pressure including zero pressure, contained within the third cylinder between the third piston and the upper end of the third cylinder;
a sixth volume (V6), filled with hydraulic fluid, contained within the third cylinder between the third piston and the lower end of the third cylinder;
a third gas accumulator, consisting of a fourth cylinder, having an upper end and a lower end, and a fourth piston located within the fourth cylinder and adapted for reciprocation with respect thereto;
a seventh volume (V7), filled with gas at any pressure including zero pressure, contained within the fourth cylinder between the fourth piston and the upper end of the fourth cylinder;
an eighth volume (V8), filled with hydraulic fluid, contained within the fourth cylinder between the fourth piston and the lower end of the fourth cylinder;
conduit means between the eighth volume (V8) and the sixth volume (V6) fitted with a means for fluid transportation;
conduit means between the fifth volume (V5) and other gas volumes (V2, V4, TV1, TV2, . . . , TVN, surroundings) adapted with a valve (VC2) for controlling flow in and out of the fifth volume (V5) via a valve (VC2) and other valves (VC1, VC3, VC4, VC5, VC6, . . . , VC(N+4)).

19. Depth compensate passive heave compensator according to claim 14, where the means for gas transportation is at least one gas compressor driven by an electric motor.

20. Depth compensate passive heave compensator according to claim 14, where the means for gas transportation is at least one pressure intensifier driven by hydraulics.

21. Depth compensate passive heave compensator according to claim 20, further comprising an energy source being at least one battery pack integrated into the mobile heave compensator.

22. Depth compensate passive heave compensator according to claim 21, where an energy source on the vessel is connected to the compensator via an umbilical.

23. Depth compensate passive heave compensator according to claim 21, where at least one of the cylinders is constituted of a predetermined number of cylinders arranged in parallel connection in order to increase the effective volume of at least one of the following: first volume (V1) of hydraulic fluid, second volume (V2) of either hydraulic fluid or gas, third volume (V3) of hydraulic fluid, fourth volume (V4) of gas, fifth volume (V5) of gas, sixth volume (V6) of hydraulic fluid and first tank volume (TV1) of gas.

24. Depth compensate passive heave compensator according to claim 23, further comprising:
sensor arrangement adapted for measuring the position of the first piston and the second piston.

25. Depth compensate passive heave compensator according to claim 24, further comprising: pressure sensor means adapted for measuring pressure in at least one volume and/or the external pressure.

26. Mobile heave compensator according to claim 25, wherein all valves and the means for fluid transportation are controlled by a computer based on logic programming that rely on input from sensor means (any pressure or position measurement).

27. Mobile heave compensator according to claim 26, wherein oil is replaced by any fluid or vacuum.

28. Mobile heave compensator according to claim 27 wherein an accumulator, actuator or tank is added in parallel or a serial connection to any of the defined accumulators, actuators or tanks.

29. Depth compensate passive heave compensator according to claim 8, further comprising:
a number of conduit means between each tank volume (TV1, TV2, . . . , TVN) and the fourth volume (V4), with a number of valve means (VA1, VA2, . . . , VAN) in each conduit means adapted for separating each tank volume (TV1, TV2, . . . , TVN) individually from the forth volume (V4);
a number of conduit means between each tank volume (TV1, TV2, . . . , TVN) and the fourth volume (V4), with a number of valve means (VB1, VB2, . . . , VBN) in each conduit means adapted for separating each tank volume (TV1, TV2, . . . , TVN) individually from the second volume (V2).
